(19) United States
(12) Patent Application Publication
(10) Pub. No.: US 2021/0045526 A1
(43) Pub. Date: Feb. 18, 2021

(54) PROTECTIVE COVER FOR SUPPORT STRUCTURES

(71) Applicant: Ricardo Derbez Nieto, Metepec (MX)

(72) Inventor: Ricardo Derbez Nieto, Metepec (MX)

(21) Appl. No.: 16/801,854

(22) Filed: Feb. 26, 2020

(30) Foreign Application Priority Data
Aug. 15, 2019 (MX) MX/A/2019/009907

(51) Int. Cl. A47B 13/08; B01L 9/02; A47B 96/20; A47B 37/00; A47B 13/00

(52) U.S. Cl. CPC A47B 13/08; B01L 9/02; A47B 96/201; A47B 2037/005; A47B 13/003; A47B 96/206; B01L 2200/08; A47B 37/00

(57) ABSTRACT

A protective cover that is positionable on a structure such as a table or a piece of laboratory furniture. The cover has at least three support structures positioned on a bottom part of the cover substantially parallel to each other. The protective cover also has at least two substrate fiber cement slabs built of reinforced organic and/or mineral fibers positioned between the support structures. A steel slab having a glassy and/or porcelain finish covers the fiber cement slabs and/or the support structures. The steel slab has three folds on the surface including two folds on the sides that correspond to a 90° angle relative to the flat part of the steel slab and a middle fold located between the side folds and creates a middle groove that forms two cavities at the bottom part of the steel slab.

### TECHNICAL FIELD

This invention belongs to the technical field of human necessity. Particularly to the technical field of tables, desks, laboratory tables and, more particularly to the technical field of coverings for such tables.

### BACKGROUND INFORMATION

The protective covers for work tables, usually, are made up by an upper slab that adapt to such tables, which could be used in analysis laboratories that work with chemicals or biological compositions; therefore they need a higher level of resistance to these and other products that could, for example, damage the surface. Furthermore, they must have certain features such as humidity resistance, properties of scratch reduction (anti-vandalism), they must not be shiny, they must reduce excessive noise caused by being hit, and also they must be resistant to heat and be durable, taking into consideration various factors in production that have an impact on the costs.

Traditionally, the table covers are a board of blocks made of a special plywood produced from a small quantity of wooden strips and, as the main material a fiber of average density that could be made of MDF boards or other products like epoxic resin, phenolic resin, stainless steel, acrylic resin, stone, granite or fiberboard. Tables in a laboratory environment could be made of any of these materials.

In regards of the boards of blocks, used in this field, it is known that they have humidity and resistance properties similar to wooden panels. However, the board of blocks is an excellent material for test benches, and unfortunately it is too expensive.

In regards of the MDF block, it is vulnerable to humidity and incubation of bacteria, which makes it impractical, for example, in an operation of bacteriological research.

In addition to the wooden covers mentioned before, it is used an upper slab made of ceramic, which is created by mixing silica with unsaturated polyester resin with a thermostable molding and a stone upper slab used to cut and process marble. Even though it has excellent advantages, not only it is expensive, but also vulnerable to impact, very heavy and inconvenient to transport or move.

In order to fix these flaws, some proposals given by the state of technique are known, they have made great effort to modify the structure and materials of table coverings, for example, the Korean request KR 20090098927 (A), which refers to a laboratory upper slab made of a ceramic material put on top of a laboratory table. The slab is approximately 30 mm thick, and a fringe made of the same material is integrated to one side of the upper slab.

Moreover, the German request DE 19944447201 (A1) proposes a laboratory table that has a base and a laboratory panel set on top of the base, the surface of the laboratory table is flat and rectangular. The surface of the table is delimited by a peripheric border and a working Surface that consists in ceramic tiles. The border has a bezel that goes in the direction of the working Surface. The upper part of the panel also has a supporting slab, where the working surface is placed. The supporting slab is made of solid wooden beams so that it results in a peripheral lateral high embossment, the high embossment is covered molding the border.

The Korean request KR 20110087471 (A) describes an upper slab from an experimentation table made of an aluminum panel molded through extruding with an adequate width using aluminum light materials in order to have the tension of a horizontal load. The upper slab of an experimentation table is formed of an aluminum panel that includes an aluminum panel, means of molding and means of conduction. The panel is molded through aluminum extrusion in order to have a part of recess and a fringed part that allow them to be interlocked in both sides. The element of molding is adjusted by a fixing bolt and fit to a vertical connection part. The means of conduction is fitted to surround the recess and fringed parts.

### SUMMARY

This invention has been done taking into account the already mentioned issues of the state of technique and its goal is to give protection to tables. Therefore, a main goal of protection refers to protective covers and support for laboratory tables in various areas, such as education, research, quality control, developing new products, clinical, pharmaceutical, self-care, food, health sector, teaching, among others.

A second goal of protection is a protective cover made with materials that are high temperature, acid and solvent resistant, also the structure must be mechanical, impact, and scratch resistant, much needed in work tables which also have a porcelain finish that creates an aseptic layer with a matt finish to avoid the reflection of shine over the operator. Furthermore, the structural elements (fiber cement) that compose the invention make it more resistant, minimize the emission of noise when the cover is hit and minimize the transmission of heat.

The goals of this invention referred to above and others which are not mentioned will be evident in the description of the invention and the figures with depictive non-limiting character that illustrate them that are shown next.

### BRIEF DESCRIPTION OF FIGURES

FIGS. 1A and 1B show a perspective of the general application of the working deck in laboratory tables according to at least three of the preferred modalities of this invention.

FIG. 1C show a perspective view of the pieces of the working deck with the components that are put beneath the work cover.

FIG. 2A show a frontal perspective view of the working deck in the first modality of this invention.

FIG. 2B shows a back perspective view of the working deck in the first modality of this invention.

FIG. 2C also shows a bottom view of the working deck in the first modality where the components of galvanized slab and fiber cement bracings can be appreciated, joined in the bottom part of the working deck.

FIG. 3A shows a frontal perspective view of the working deck in the second modality of this invention.

FIG. 3B shows a back perspective view of the working deck in the second modality of the invention.

FIG. 3C also shows a bottom perspective view of the working deck in the second modality where the components of galvanized slab and fiber cement bracings can be appreciated, joined in the bottom part of the working deck.

FIG. 4A shows a frontal perspective view of the working deck in the third modality of this invention.

FIG. 48 show a bottom view of the working deck where the components of galvanized slab and fiber cement bracings can be appreciated, joined in the bottom part of the working deck.

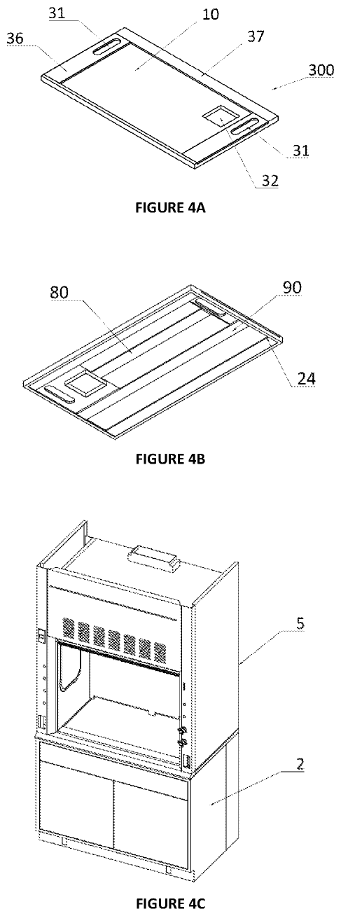

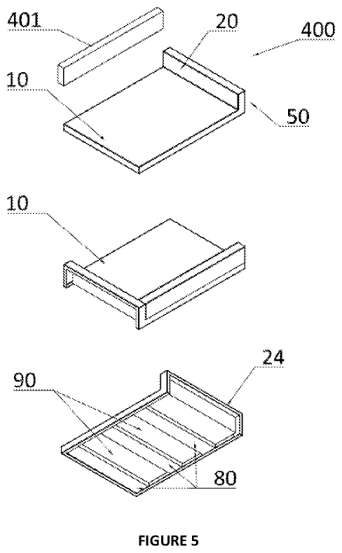

FIG. 4C shows an ensemble of laboratory table and extraction hood in which the working deck, object of the third modality of this invention is found.

FIG. 5 shows a perspective view of the working deck in the fourth modality of this invention.

### DESCRIPTION OF THE INVENTION

The following detailed description refers to the attached drawings. The same reference numbers in different drawings may stand for similar or the same elements.

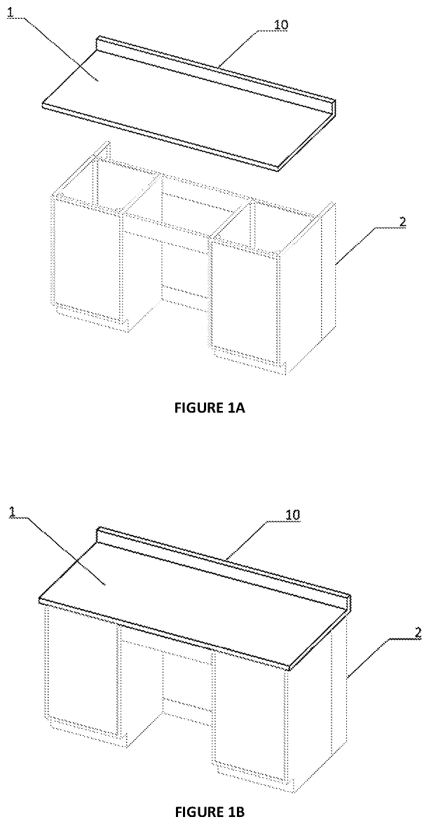

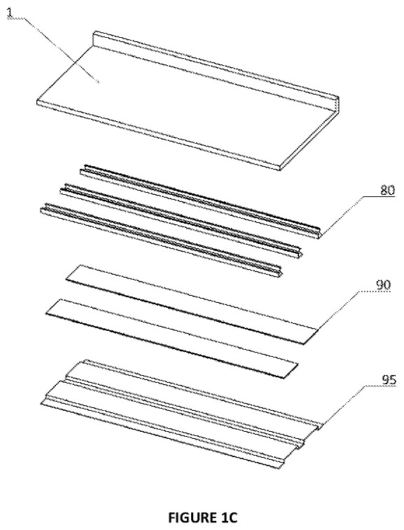

As can be seen in FIGS. 1A and 1B, the protective cover (1) to which this invention refers (10), is designed to be built or assembled on top of a support structure of a table or laboratory furniture (2). In which one of the characteristics of such protective cover (1), is that the surface is flat in order to perform laboratory activities on top of it.

In FIG. 1C the components that give hardness to the protective cover (1) can be seen when it is assembled on top of the support structure of such table or piece of laboratory furniture (2), which are made up of at least three support or bracing structures (80) at the bottom part. The bracings (80) are bent in an omega shape and are 70 mm wide, 30 mm high and 1970 mm long. They are fabricated in cold forming steel slab caliber 18. These bracings (80) are set in parallel.

At the bottom part of the bracings (80) the protective cover also has at least two slabs of substrate of fiber cement (90) 6 mm wide, built with reinforced mineral and organic fibers, these characteristics give thermic and acoustic protection to the cover when working on the Surface of that protective cover (1), those fiber cement slabs (90) are covered at the same time with “trascara” which is a steel slab (95) in cold forming caliber 20 with a flux finish (glassy, porcelain finish), which gives it the technical advantage to the slab of having the same protective, aseptic, mechanical and chemical characteristics as the working surface (porcelain). Also, it has enough mechanical resistance to impact, the dimensions of the slabs are 185 mm wide and 1970 mm long. The steel slab (95) has three folds on the surface, the lateral folds correspond to a 90° angle according to the flat part of the steel slab while the middle folding ids found in that zone of the slab (95) and creates a middle groove that at the same time creates two cavities at the bottom of the steel slab.

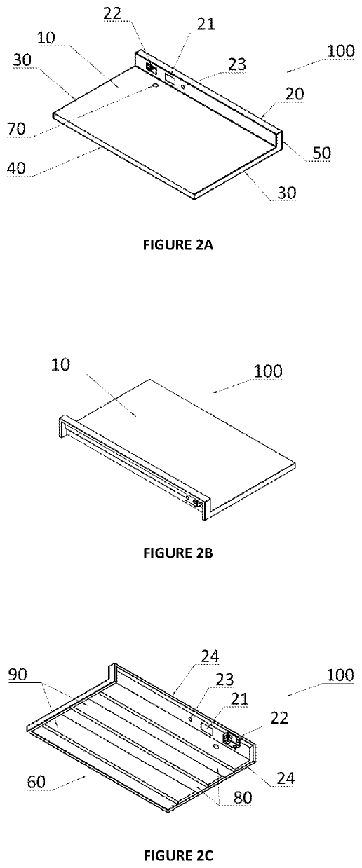

As it is shown in FIGS. 2A, 2B, and 2C as the first preferred modality of the invention, there is a protective cover (100) which will be assembled on top of the support structure of a table or a piece of laboratory furniture (2) as it was previously shown in FIGS. 1A, and 1B.

The protective cover (100) is defined mainly by a substantial rectangular steel slab in cold forming caliber 20 with a porcelain finish, a frontal extreme (40) and a back extreme (50), a flat upper surface (10) and a bottom Surface (60). The dimension of the working surface preferably is of 1200 mm×762 mm front and deep, and has a slab width of 33 mm, the fringe (20) integrated to the cover is 40 mm wide and 80 mm long.

As it can better be seen on FIG. 2A, the upper flat Surface (10) of the protective cover (100) has a drill hole (70) with 51 mm diameter, which has as a main goal, to install a step of plastic cables, also hoses (not shown) or any other conduct to be connected to the bottom part of the table (2) without the need of passing them in front of the table in order to avoid the possibility of an accident.

The vertical extrusion (20) also has three extricates (21, 22, 23) in which two of the extricates (21, 22) are defined by rectangular cut outs, and the third extricate (23) is defined by a drill hole. The first rectangular cut out (22) is located at less than 150 mm from the left extreme, and has a dimension of 70 mm×40 mm in length and height, and has a welded sloop that over shows from the back part of the vertical extrusion (20), the sloop has at least two drillings through the lateral and frontal extremes put at 5 mm from the external border from inside to outside, each one of them has a 4 mm diameter, the second cut out (21) is located at 100 mm from the other one, and has a dimension of 70 mm×40 mm long and tall, and the third cut out is a drill hole (23) located at 120 mm from the second rectangular cut out from outside to the inside, this drill hole (23) is located in the central part of the vertical extrusion (20) and has a diameter of 19 mm. The function of the first cut out (22) is for connecting voice and data service, the second cut out (21) is for setting up electric outlets of 110V or 220V, simple or double and the drill hole (23} is for setting up Python wrenches (not-shown) for any type of hydraulic system of industrial grade such as: air, vacuity, nitrogen, helium, gas, water, etc.

FIG. 2C shows a support device set up on the bottom part of the protective slab (100) that is used to give hardness when the protective slab (100) is set up on top of the support structure of the table or piece of laboratory furniture (2) through means of fixation like, for example, screws, having also the technical advantage of absorbing noise when the slab is hot with a piece while working.

This support device is composed mainly by an ensemble of three support structures (80) folded in an omega shape which are attached, preferably stuck along the bottom flat Surface of the protective cover (100), two fiber cement substrate slabs (90) are covered with “trascara” that is a steel slab molded in cold caliber 20 with flux finish (glassy, porcelain finish). These slabs are attached and set up between the omega shaped support structures (80).

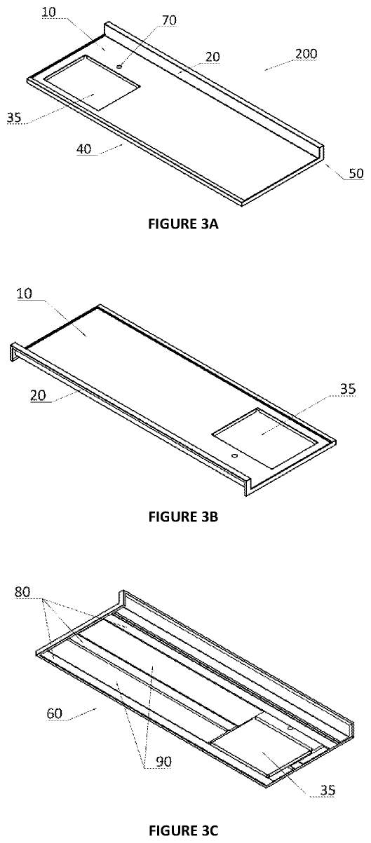

A second modality of this invention can be appreciated in FIGS. 3A to 3C, which show a protective cover (200) for work that will be set up on top of the support structure of a table or a piece of laboratory furniture (2) just as it was previously shown through FIGS. 1A and 1B.

The protective cover (200) is defined mainly by a substantially rectangular steel slab molded in cold caliber 20, with a porcelain finish, a frontal extreme (40) and a back extreme (50) with a vertical extrusion (20) integrated to the back extreme (50), a flat upper Surface (10) and a bottom Surface (60), the dimension of the working surface is preferably of 2000 mm×762 mm front and deep, and with a width of the slab of 33 mm, the fringe (20) integrated to the cover is of 40 mm wide and 80 mm tall. This vertical extrusion (20) and protective cover (200) have a fold in the back and bottom part of 15 mm all perimeter long.

As it is shown in FIG. 3A, the upper flat surface (10) of the protective cover (200) has a cut out (35) in the shape of a rectangular window with dimensions of 390 mm×510 mm, set at 70 mm from the left lateral extreme from the outside to the inside and at 85 mm from the lateral frontal extreme from the outside to the inside, in order to set up a wash trough. Also, it has a drill hole (70) of 32 mm diameter, set at 325 mm from the frontal extreme from the outside to the inside. This is for the setup of a gooseneck water tap (not shown).

FIG. 3C shows a support device on the bottom part of the protective cover (200) that is used to give hardness to the protective slab (200) when installed on top of the support structure of a table or piece of laboratory furniture (2), obtaining also the technical advantage of avoiding non-desired flexion or torsion, thickening the piece and having a fixing point in the support structure.

This support device is compounded mainly by three support structures (80) folded in an omega shape, which are welded and attached along the flat bottom surface of the protective cover (200), two substrate fiber cement slabs (90) 6 mm wide are attached to the bottom face of the cover, these fiber cement slabs (95) are molded in cold caliber 20 with a flux finish (glassy, porcelain finish), these slabs (95) are sealed in its perimeter, preferably with glue and are set up between the omega shaped support structures (80).

FIGS. 4A and 4B stand for a third modality of this invention and show a protective cover (300) which will be set up on top of a support structure of a piece of laboratory furniture such a laboratory table (2) and an extraction hood (5) as it can be better appreciated in FIG. 4C.

This protective cover (300) is defined by a substantially rectangular slab made of steel slab molded in cold caliber 18 with a porcelain finish. The general dimensions of the working surface are 1219 mm×664 mm front and deep and the width of the slab is 33 mm. The protective cover (300) has a deep finish delimited by a frontal extreme of 20 mm, a back extreme of 76 mm and two lateral slabs (36) in a U shape with a service cut out (31) 568 mm×122 mm×10 mm front, deep and tall. The protective cover (300) has a fold (24) at the bottom part of 15 mm in all of the perimeter.

As it is shown in FIG. 4A, the upper flat surface (10) has three cut outs (31, 32, 33), two (31) lateral and a central one (32), the first two with dimensions 60×50 mm in an oval shape set at 143 mm from the back extreme to the front and at 61 mm from the lateral extreme to the center, having the main goal of passing cupper pipes, galvanized or hoses (not shown) or any other conduct to be connected to the bottom part of the piece of furniture without the need of passing them across the frontal part of it and avoiding a possible accident. The third (central) cut out with dimension of 150 mm×150 mm set at 143 mm from the back extreme from the inside to the outside and at 162 mm from the left lateral extreme to the center to make a jug collocation.

This cover has three support structures in the bottom part (80), folded in an omega shape and attached along the protective cover (300), these support structures (80) are 70 mm wide, 30 mm tall, and 1189 mm long each, which are produced with steel slab molded in cold caliber 18.

It also has two fiber cement slabs (90) 6 mm wide (built by reinforced mineral and organic fibers) attached to the interior face of the cover, these fiber cement slabs (90) are covered with “trascara” (95) which is a steel slab molded in cold caliber 20 with a flux finish (glassy, porcelain finish), these slabs are sealed at the perimeter by black silicone and are installed on the omega shaped support structures. The dimensions of the slabs are 185 mm wide, the second one of 115 mm, and the third one 120 mm, all three of them 1189 mm long.

Still a fourth modality of this invention is shown in FIG. 5, in which the protective cover (400) for work is specially conceived to be set up on the support structure of a table or a piece of laboratory furniture (2) just as it has been shown in FIGS. 1A and 1B.

As it can be better appreciated in FIG. 5, the upper flat surface (10) has a portable extrusion (401) of 78 mm tall to even an integrated back vertical extrusion (20). This portable extrusion (401) does not make an integral part of the cover and it is used for covering attached spaces perpendicularly and for giving continuity to the work table 2.

This protective cover (400) has three support structures (80) at the bottom part, folded in an omega shape and attached along the cover on the bottom part, these support structures (80) have a width of 70 mm, 30 mm tall and 420 mm long each. They are produced in steel slab molded in cold caliber 18.

It also has two substrate fiber cement slabs (90) 6 mm wide (built of reinforced organic and mineral fibers) attached to the inferior face of the cover, these fiber cement slabs (90) are covered with “trascara” (95) which is a steel slab molded in cold caliber 20 with a flux finish (glassy, porcelain finish), these slabs are sealed at their perimeter with black silicone, these slabs are set up between the omega shaped support structures (80), the dimensions of the slabs are 185 mm wide and 420 mm long.

The design of the various elements that compose the protective cover, give the structure and hardness needed to bear heavy equipment, as well as chemical and heat resistance in case of spilling.

Among the advantages, primarily is that the material is more flexible (steel molded in cold) in comparison to a glassy ceramic that could be the closest to this product, which allows adjustment in the site to adequate to laboratory space, furthermore, the design allows the integration of uniformity in other covers (setup of one piece next to the other). Its finishes (polish finished steel) allows heat and various chemical and solvent resistance when used in a laboratory, in which the matt finish avoids the reflex of shine over the operator and it is resistant to scratch and stains. The structural components avoid the noise that hitting metal with metal can cause; in other words, it absorbs noise. It is a product that can be repaired in case of spalling in site.

The protective cover does not present any sags during usage, so an additional material to adjust the equipment or fit the table to keep a perfect evenness is not needed, which does not creates a higher Price or an unevenness that could affect the laboratory equipment while testing.

Another advantage is that the protective cover can be integrated in different elements that help improving the aesthetics of the laboratory like the electric outlets, voice and data outlets, wash troughs, taps, cable holes, location of vibrating balances, etc.

Additionally, adjustments in site can be made, according to the measurements found in the space and that keep its composition, structure and aesthetics, which is the biggest issue in the field.

Even though, the above description was made taking into account the preferred modalities of the invention, experts in the field should mind that any modification in shape and detail will be comprehended in the spirit and reach of the invention. The terms in which this memory has been written should be taken in a wide non-limitative sense. The materials, shape and description of the elements will be susceptible to variation as long as it does not include an alteration of the essential characteristics of the model.

1. A protective cover for table, a piece of laboratory furniture and the like, the protective cover comprising:
an upper flat surface and an opposed bottom flat surface;
at least three support structures positioned at the bottom surface of the protective cover and folded in an omega shape, wherein the at least three support structures are set up in a parallel way between them;
at least two substrate fiber cement slabs positioned between the at least three support structures and, built of reinforced organic and mineral fibers that gives thermic and acoustic protection to the cover; and
a steel slab configured to form a cover that covers the fiber cement slabs, wherein the steel slab has three folds on the surface, and two folds on the sides that correspond to a 90° angle in respect to a flat part of the steel slab, and wherein a middle fold is located in the steel slab and creates a middle groove that forms two cavities at a bottom part of the steel slab.

2. The protective cover of claim 1, wherein the protective cover is a substantially rectangular steel slab with a porcelain finish, wherein the protective cover has a frontal extreme and a back extreme, a left extreme and a right extreme.

3. The protective cover of claim 2, wherein a drill hole is defined from the upper flat surface through the bottom surface so that wires, hoses and the like can extend through the protective cover.

4. The protective cover of claim 2, further comprising a vertical extrusion extending away from the upper flat surface and defining three cut outs, in which two of the cut outs are rectangular cut outs, and the third cut out is defined by a drill hole, wherein a first rectangular cut out is located at a spaced distance from the left extreme and has a welded sloop that extends away from a back part of the vertical extrusion, wherein the sloop defines at least two drillings at lateral and frontal extremes spaced from an external border of the vertical extrusion, wherein the second cut out is spaced from the first cut out, and wherein the third cut out is spaced from the second rectangular cut out, and wherein the drilling hole is located at a central part of the vertical extrusion.

5. The protective cover of claim 1, wherein the support structures are welded and attached along the bottom flat surface of the protective cover, wherein the two substrate fiber cement slabs are attached to an interior face of the cover, wherein the steel slab has a flux finish, and wherein the steel slab is sealed along its perimeter by silicone.

6. (canceled)

7. The protective cover of claim 1, wherein the protective cover further comprises a frontal extreme and a back extreme with a vertical extrusion integrated to that back extreme, and wherein the vertical extrusion and the protective cover have a fold on the back and bottom part along a perimeter.

8. The protective cover of claim 7, wherein a rectangular window is defined from the upper flat surface to the bottom flat surface, wherein the window is sized and shaped to set up a wash trough therein, wherein a drill hole is defined from the upper flat surface to the bottom flat surface, and wherein the drill hole is positioned between the window and the vertical extrusion.

9. The protective cover of claim 1, wherein the at least three support structures are welded and attached to the entirety of the length of the flat bottom surface, and wherein the steel slab is sealed along a perimeter edge and between the omega shaped support structures.

10. The protective cover of claim 1, wherein the protective cover is configured to be positioned between the furniture and an extraction hood.

11. The protective cover of claim 10, wherein a first lateral cutout, a second lateral cutout and a central cut out are defined from the upper flat surface through the bottom surface so that cupper tubes, galvanized, hoses and the like can be connected from the top to the bottom part of the piece of furniture without having to pass it across the frontal part to avoid any potential accidents, and wherein the first and second lateral cut outs are oval in shape.

12. The protective cover of claim 1, wherein the at least two cement slabs are attached to an interior face of the cover, wherein the cover is molded with a glassy, porcelain finish and wherein the cement slabs are sealed around a perimeter with black silicone.

13. The protective cover of claim 1, further comprising an integrated vertical extrusion extending away from the upper flat surface and a portable extrusion in which the portable extrusion is not formed integrally with the cover and is used for covering spaces perpendicularly.

14. (canceled)

15. A work surface comprising:
an upper flat surface and an opposed bottom flat surface;
at least three support structures coupled to the bottom surface, wherein the at least three support structures are formed into an omega shape, and wherein the at least three support structures are substantially parallel to and spaced from each other;
at least two substrate fiber cement slabs formed from reinforced organic and mineral fiber to provide thermal and acoustic protection to the work surface, wherein at least one fiber cement slab is positioned between each of the at least three support structures; and
a covering coupled to the bottom surface, the covering configured to enclose the at least three support structures and the at least two fiber cement slabs, wherein the covering has three folds in a central portion and and two folds on each longitudinal side of the covering, wherein the folds form a plurality of grooves in the covering, and wherein each support structure is positioned in a groove.

16. The work surface of claim 15, wherein the covering comprises a recessed surface formed between adjacent grooves, and each recessed surface overlies a fiber cement slab.

17. The work surface of claim 16, wherein each recessed surface is positioned between adjacent support structures.
